(19) United States
(12) Patent Application Publication
(10) Pub. No.: US 2019/0070778 A1
(43) Pub. Date: Mar. 7, 2019

(54) ADDITIVE MANUFACTURING SYSTEMS AND PROCESS AUTOMATION

(71) Applicant: Cincinnati Incorporated, Harrison, OH (US)

(72) Inventors: Christopher Haid, Newton, MA (US); James Pershken, Newton, MA (US); Alfonso Perez, Orlando, FL (US)

(21) Appl. No.: 15/998,470

(22) Filed: Aug. 15, 2018

Related U.S. Application Data
(60) Provisional application No. 62/545,655, filed on Aug. 15, 2017.

(51) Int. Cl. B29C 64/329; B29C 64/118; B29C 64/295; B29C 47/08; B29C 47/38; B22F 3/20

(52) U.S. Cl. CPC B29C 64/329; B29C 64/118; B29C 64/295; B33Y 10/00; B29C 47/38; B22F 3/20; B22F 2003/208; B29C 47/0805

(57) ABSTRACT

An additive manufacturing system includes a hopper for containing a feedstock, at least one helical drive positioned downstream from the hopper for receiving the feedstock therefrom, a heat source positioned proximate at least a portion of the at least one helical drive, and an outlet. The at least one helical drive is configured to advance the feedstock toward the outlet, the heat source is configured to at least partially liquefy the feedstock advanced by the at least one helical drive, and the outlet is configured to dispense the at least partially liquefied feedstock based on a desired toolpath. The at least one helical drive may include at least one of a screw, a bolt, an auger, or an Archimedean screw.

### CROSS-REFERENCE TO RELATED APPLICATION

This application claims the benefit of U.S. Provisional Patent Application Ser. No. 62/545,655 filed Aug. 15, 2017, the disclosure of which is incorporated by reference herein in its entirety.

### FIELD OF THE INVENTION

The present invention relates generally to additive manufacturing systems and methods and, more particularly, to additive manufacturing systems including a helical drive or screw extruder for advancing feedstock to a heat zone to at least partially liquefy the feedstock.

### BACKGROUND OF THE INVENTION

With reference now to FIG. 1, a common prior art extrusion method for filament or rod-based additive manufacturing systems is shown. The system 10 depicted in FIG. 1 is mechanically similar to a rack and pinion where the filament or rod 12 behaves as the rack and the gear or hobbed gear 14 used to drive the filament 12 behaves as the pinion. When extrusion additive manufacturing systems utilizing a filament or rod drive system similar to FIG. 1 operate correctly, the gear or hobbed gear 14 applies enough downward pressure to the filament or rod 12 to drive the filament 12 into the heat zone of the extruder (not shown) and to overcome the pressure drop that occurs at the nozzle. Extrusion additive manufacturing systems utilizing a filament or rod drive system similar to FIG. 1 rely on the mechanical integrity of the filament-hobbed gear interaction, filament-gear interaction, rod-hobbed gear interaction, or rod-gear interaction to drive and control the accuracy of the extrudate. Typically, extrusion additive manufacturing systems that utilize a filament or rod drive system similar to FIG. 1 suffer from several common failure modes that limit the ultimate accuracy of the system. These failure modes include, but are not limited to, slipping between the filament 12 and drive gear or hobbed gear 14, shearing of the filament or rod 12 by the gear or hobbed gear 14 which may cause the gear or hobbed gear 14 to freely spin in the cavity that was previously filament or rod, snapping of the filament or rod 12, buckling of the filament or rod 12, necking of the filament or rod 12, or plastic deformation of the filament or rod 12. Filaments and rods 12 are commonly made from polymer materials. It is understood that many new composite materials are being used such as bound metal filaments, bound metal rods, bound ceramic filaments, bound ceramic rods, bound glass filaments, bound glass rods, bound rock filaments, bound rock rods, bound carbon fiber filaments, bound carbon fiber rods. It is also assumed that new filaments and rods may be developed which will continue to rely on the fundamental filament or rod drive system 10 depicted in FIG. 1 and which may include but are not limited to graphite, wood, bamboo, basalt, and cermets.

With reference now to FIG. 2, a common prior art configuration of bound filament or bound rod raw materials for extrusion additive manufacturing systems is shown. These bound filaments or rods 12 may contain metal, ceramic, and/or a carbon allotrope 20, and/or a polymer 22 in addition to a binding agent, lubricant, and/or surfactant 24. It is commonly understood that these filaments or rods 12 may contain any one of the materials listed above or any combination thereof. When a part is additively manufactured using a bound filament or rod 12, for example a metal filament or rod 12, the 3D part is then subjected to subsequent debind and sintering steps in the process to ensure a high-density, high-purity metal part is manufactured.

When bound filaments or rods 12 are manufactured, they can come with many common defects that make the resulting filament or rod 12 difficult to feed through an extruding system 10 similar to that of FIG. 1. Bound filaments and rods 12 can contain defects that make it difficult to use in an extrusion additive manufacturing system 10. These defects include, but are not limited to, slipping between the filament 12 and drive gear or hobbed gear 14 caused by imperfections in the diameter of the filament or rod 12, shearing of the filament or rod 12 by the gear or hobbed gear 14 which may cause the gear or hobbed gear 14 to freely spin in the cavity that was previously filament or rod 12, snapping of the filament or rod 12 commonly caused by over packing of bound powders within the filament or rod 12, buckling of the filament or rod 12, necking of the filament or rod 12, or plastic deformation of the filament or rod 12. Filaments and rods 12 are commonly made from polymer materials. It is understood that many new composite materials are being used such as bound metal filaments, bound metal rods, bound ceramic filaments, bound ceramic rods, bound glass filaments, bound glass rods, bound rock filaments, bound rock rods, bound carbon fiber filaments, bound carbon fiber rods. For example, these filaments or rods 12 are typically 40%-80% bound metal powder by volume with the remainder of the volume of the filament 12 occupied by a binder or lubricant. Another difficulty with making high-density filaments or rods 12 is the brittle nature of the resulting filament or rod 12. When the percentage of bound material (e.g. metal, ceramic, rock etc.) exceeds 30%, the resulting filament or rod 12 becomes substantially more brittle than an equivalent geometry 100% polymer filament or rod 12. The impact of increased brittleness is that extruding systems 10 similar to the configuration shown in FIG. 1 are significantly more susceptible to jamming or failure causing a disruption to the additive manufacturing process. In order to manufacture and handle high-density bound filaments or rods 12 the manufacturer must ensure that the material is strong enough and not brittle so as to be fed through the filament or rod drive system 10, typically resulting in the use of non-optimal binding agents, lubricants, or surfactants 24 for the debinding and sintering phases.

Thus, it would be desirable to provide an improved additive manufacturing system.

### SUMMARY

In one embodiment, an additive manufacturing system includes a hopper for containing a feedstock, at least one helical drive positioned downstream from the hopper for receiving the feedstock therefrom, a heat source positioned proximate at least a portion of the at least one helical drive, and an outlet. The at least one helical drive is configured to advance the feedstock toward the outlet, the heat source is configured to at least partially liquefy the feedstock advanced by the at least one helical drive, and the outlet is configured to dispense the at least partially liquefied feedstock based on a desired toolpath. The at least one helical drive may include at least one of a screw, a bolt, an auger, or an Archimedean screw. In addition or alternatively, the additive manufacturing system may further include a mixing subsystem positioned upstream from the at least one helical drive for mixing at least one of the feedstock, a lubricant, or a binder. For example, the mixing subsystem may include at least one of a vibrator, a rotating shaft, a magnet, a paddle, a brush, a stirrer, a single sigma mixer, a dual sigma mixer, a fluid flow, a liquid flow, or a gas flow. In one embodiment, the at least one helical drive and the mixing subsystem are driven in unison with each other. In another embodiment, the at least one helical drive and the mixing subsystem are driven independently of each other.

In one embodiment, the hopper includes at least one protrusion for controlling flow of the feedstock from the hopper. For example, the at least one protrusion may be at least one of stationary, rotatable, linearly movable, extendable in length and/or retractable in length. In addition or alternatively, the at least one helical drive may be linearly movable relative to the outlet. For example, linear movement of the at least one helical drive relative to the outlet may be controllable. In addition or alternatively, the additive manufacturing system may further comprise an actuator for driving the at least one helical drive, wherein the actuator is operatively coupled to the at least one helical drive by a coupler constructed of at least one thermally resistive material. For example, the coupler may be constructed of at least one of a polymer, a ceramic, a metal, or a carbon allotrope.

In one embodiment, the additive manufacturing system further includes a flexible tube positioned between the at least one helical drive and the outlet. For example, the flexible tube may be actively heated. In addition or alternatively, the additive manufacturing system may further include a feedstock comprising a non-filament material, wherein the feedstock is contained in the hopper. For example, the feedstock may be selected from the group consisting of polymer pellets, polymer granules, polymer powders, polymer gels, polymer suspensions, polymer micro pellets, metal pellets, metal granules, metal powders, metal gels, metal suspensions, metal micro pellets, graphite pellets, graphite granules, graphite powders, graphite gels, graphite suspensions, graphite micro pellets, ceramic pellets, ceramic granules, ceramic powders, ceramic gels, ceramic suspensions, ceramic micro pellets, and/or combinations or composites thereof.

In another embodiment, an additive manufacturing system includes a tank for containing a feedstock, a pump positioned downstream from the tank for receiving the feedstock therefrom, a heat source positioned proximate the pump, and an outlet, wherein the pump is configured to advance the feedstock toward the outlet, wherein the heat source is configured to at least partially liquefy the feedstock advanced by the pump, and wherein the outlet is configured to dispense the at least partially liquefied feedstock based on a desired toolpath. The additive manufacturing system may further include a flexible tube positioned between the helical drive and the outlet. For example, the flexible tube may be actively heated.

In yet another embodiment, a method of manufacturing includes feeding a feedstock into a hopper, advancing the feedstock from the hopper through a heat zone via a helical drive, at least partially liquefying the feedstock in the heat zone, and dispensing the at least partially liquefied feedstock based on a desired toolpath.

### BRIEF DESCRIPTION OF THE DRAWINGS

Various additional features and advantages of the invention will become more apparent to those of ordinary skill in the art upon review of the following detailed description of one or more illustrative embodiments taken in conjunction with the accompanying drawings. The accompanying drawings, which are incorporated in and constitute a part of this specification, illustrate one or more embodiments of the invention and, together with the general description given above and the detailed description given below, serve to explain the one or more embodiments of the invention.

FIG. 1 is a perspective view of a prior art gear or hobbed gear driven filament based extrusion 3D printer head.

FIG. 2 is a cross sectional view of a prior art bound powder filament used in conventional filament based extrusion 3D printers.

FIG. 3 is a cross sectional view of an additive manufacturing system including a hopper or material inlet, a mixing system, a helical drive, a heat source, and an outlet, in accordance with an embodiment of the invention.

FIG. 3A is a cross sectional view similar to FIG. 3, showing a series of protrusions for controlling the flow of feedstock from the hopper.

FIG. 4 is a schematic view of an additive manufacturing system including a powder and pellet inlet, a mixing and agitation zone, a helical drive, a heatsink, and a heat source, in accordance with another embodiment of the invention.

FIG. 5 is a cross sectional view of an additive manufacturing system including a binder and lubricant feed port, a separate filler material and surfactants feed port, a hollow mixing shaft with mixing paddles affixed on the outside surface of the hollow mixing shaft which is contained within the mixing zone, a hollow mixing shaft containing a concentrically aligned helical drive or auger that is independently driven from the mixing shaft, and a material outlet nozzle, in accordance with another embodiment of the invention.

FIG. 6 is a partial cross sectional view of an additive manufacturing system similar to that shown in FIG. 5, wherein the distance between the helical drive or auger and the nozzle body is adjustable by varying the height of the helical drive or auger relative to the nozzle body, in accordance with another embodiment of the invention.

FIG. 7 is a partial schematic view of an additive manufacturing system similar to that shown in FIGS. 5 and 6, wherein a motor is used to turn a helical drive, and wherein the motor is indirectly coupled to the helical drive via a polymeric, ceramic, or metallic material which is used to thermally insulate the helical drive from the motor, in accordance with another embodiment of the invention.

FIG. 8 is a cross sectional view of an additive manufacturing system including a hopper or material inlet, a mixing system, and a helical drive, that are each thermally isolated or separated from the heat source and outlet, in accordance with another embodiment of the invention.

FIG. 9 is a cross sectional view of an additive manufacturing system including a hopper or material inlet, a mixing system, a helical drive, a heat source, and an outlet, that are all thermally connected, in accordance with another embodiment of the invention.

FIG. 10 is a cross sectional view of an additive manufacturing system including a tank for containing feedstock that is a gel or liquid, a pump which moves the feedstock to the 3D print head nozzle, a flexible and low friction tube which connects the pump to the 3D print head nozzle, and a 3D print head nozzle which extrudes the feedstock to form a 3D printed part, in accordance with another embodiment of the invention.

FIG. 11 is a perspective view of an additive manufacturing system including multiple independent helical drive extruders, in accordance with another embodiment of the invention.

FIG. 12 is a perspective view of a helical drive having a modular or interlocking configuration, in accordance with another embodiment of the invention.

FIG. 13 is a cross sectional view of an additive manufacturing system including a helical drive including two screws which may be operated together or independently, in accordance with another embodiment of the invention.

FIG. 14 is a block diagram of various subsystems for automating 3D printing, debinding, sintering, HIP, and finishing processes for a variety of 3D printing techniques and materials, including metals and ceramics, in accordance with another embodiment of the invention.

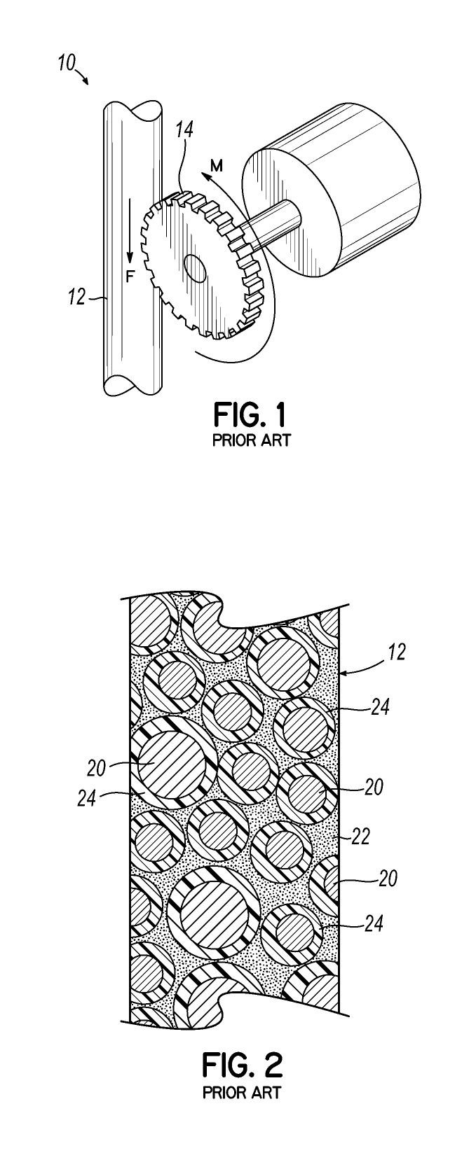

### DETAILED DESCRIPTION OF THE INVENTION

The present disclosure provides methods for using and controlling the flow of commodity pellet, powder, and gel feedstock for extrusion additive manufacturing systems that may solve one or more of the cost, quality, and/or mechanical disadvantages of filament feedstocks (spooled and rod among others) discussed above in conjunction with the prior art. The present disclosure also provides structures and methods that provide rapid and precise extrusion capability using non-filament feedstocks in extrusion additive manufacturing systems at a much lower cost. These non-filament feedstocks include but are not limited to polymer pellets, polymer granules, polymer powders, polymer gels, polymer suspensions, metal pellets, metal granules, metal powders, metal gels, metal suspensions, graphite pellets, graphite granules, graphite powders, graphite gels, graphite suspensions, and composites thereof.

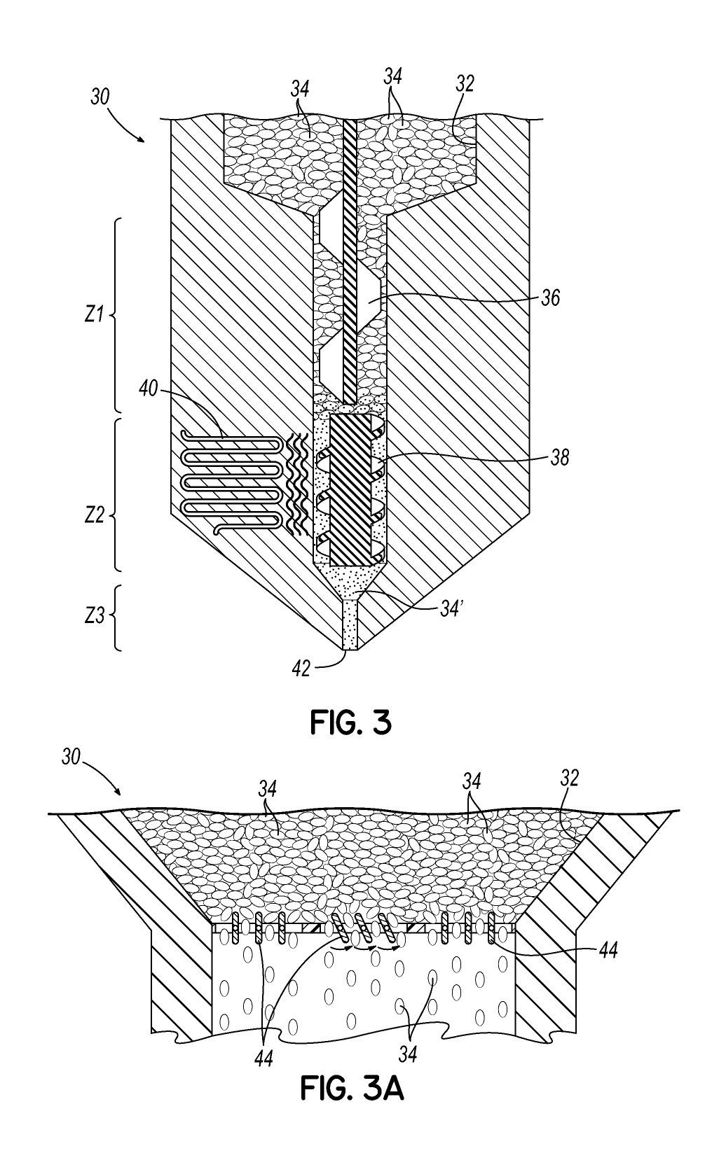

With reference now to FIG. 3, an exemplary additive manufacturing system 30 includes a hopper 32 containing any one or combination of feedstock 34, a mixing subsystem 36 at least partially defining a mixing zone Z1, a helical drive 38, a heat source 40 at least partially defining a heat zone Z2, and an outlet nozzle 42 at least partially defining an extrusion zone Z3. While the heat zone Z2 is shown as extending along substantially the entire length of the helical drive 38, it will be appreciated that the heat zone Z2 may extend along only a portion of the helical drive 38, such as, for example, near one end of the helical drive 38 and/or near a central portion of the helical drive 38. The helical drive 38 may include any helical method or mechanism such as, for example, a screw, bolt, auger, or Archimedean screw. The hopper 32 may include any device or container for containing feedstock 34 such as, for example, a box, cartridge, tube, tub, jar, cylinder, receptacle, vessel, canister, repository or any such device for containing feedstock 34.

As shown in FIG. 3A, the hopper 32 may have a single or series of protrusions 44 at or near the interface between the hopper 32 and the helical drive 38 and/or the interface between the hopper 32 and the mixing zone Z1 for the purpose of controlling or influencing the flow of feedstock 34 from the hopper 32 into the helical drive 38 or mixing zone Z1. The protrusion(s) 44 may be one or a combination of stationary, rotatable, linearly movable, and/or extendable or retractable in length. The protrusion(s) 44 may be made of magnetic material. The protrusion(s) 44 may have the ability to conduct electricity or emit an electromagnetic field for the purposes of affecting the path of feedstock 34. The protrusion(s) 44 may be uniform about a central axis. The protrusion(s) 44 may serve as a filter or be filter shaped (e.g., screen shaped). The protrusions 44 may naturally vibrate or be forced to vibrate at or near the natural frequency of the protrusion(s) 44.

Feedstock 34 may refer to any non-filament materials such as polymer pellets, polymer granules, polymer powders, polymer gels, polymer suspensions, polymer micro pellets, metal pellets, metal granules, metal powders, metal gels, metal suspensions, metal micro pellets, graphite pellets, graphite granules, graphite powders, graphite gels, graphite suspensions, graphite micro pellets, ceramic pellets, ceramic granules, ceramic powders, ceramic gels, ceramic suspensions, ceramic micro pellets, and/or combinations or composites thereof.

As shown, feedstock 34 is fed into the helical drive 38 from the hopper 32. An actuator (not shown) controls the rotation of the helical drive 38. The force from the helical drive 38 applied to the feedstock 34 causes the feedstock 34 to traverse the helical drive 38 into the heat zone Z2. Once the feedstock 34 enters the heat zone Z2, the feedstock 34 is wholly or partially liquefied from the heat. The wholly or partially liquefied feedstock 34′ continues past the heat zone Z2 into the outlet nozzle 42. Once the wholly or partially liquefied feedstock 34′ material passes through the outlet nozzle 42, the material is deposited by the 3D printer or additive manufacturing system 30 based upon the desired toolpath. Pellet sizes, independent of material type, may generally fall in the range of 10 micrometers to 10 millimeters in length, width, thickness or diameter. Powder sizes, independent of material type, may generally fall in the range of 100 nanometers to 500 micrometers. When 3D printing with metal powder, ceramic powder, or other powder typically, but not always, a lubricant or binder is used. The powder, by volume, may occupy anywhere from 20% to 90% of the volume while the remainder of the volume may be approximately occupied by the lubricant or binder used.

The helical drive 38 may be of any suitable diameter. For example, the helical drive 38 may have a diameter between 2 millimeters and 200 millimeters. In one embodiment, the helical drive 38 may not comprise a perfect helix. For example, a tapered helical drive may be used for certain materials. In one embodiment, the changes in helical drive geometry may be defined by a compression ratio ranging from 1:1 to 1:10. In addition or alternatively, the relative length of the helical drive to the diameter of the helical drive (i.e., the L/D ratio) may range from 1:1 to 40:1n embodiments wherein metal injection molding feedstock is used or ceramic injection molding feedstock is used, the overall pellet sizes may range from 10 micrometers to 10 millimeters while the powder bound within the pellet may range from 100 nanometers to 500 micrometers. For example, the pellet sizes may range from 100 micrometers to 10 millimeters and/or the powder sizes may range from 500 nanometers to 100 micrometers. Many different methods may be used to directly rotate the helical drive 38 or indirectly cause the helical drive 38 to rotate. These methods may include but are not limited to direct drive via an insulative motor coupling, direct drive via a non-insulative motor coupling, a timing belt, a gearbox interface, a chain and sprocket interface or any other device to convert electromechanical kinetic energy into mechanical rotational energy. It is well understood to those skilled in the art that feedstock raw materials may include undesired material, impurities, or flaws. In on embodiment, the system 30 may include a screen, mesh screen, filter, magnet, or other means to separate impurities from the bulk of the feedstock 34 between the helical drive 38 and the outlet nozzle 42.

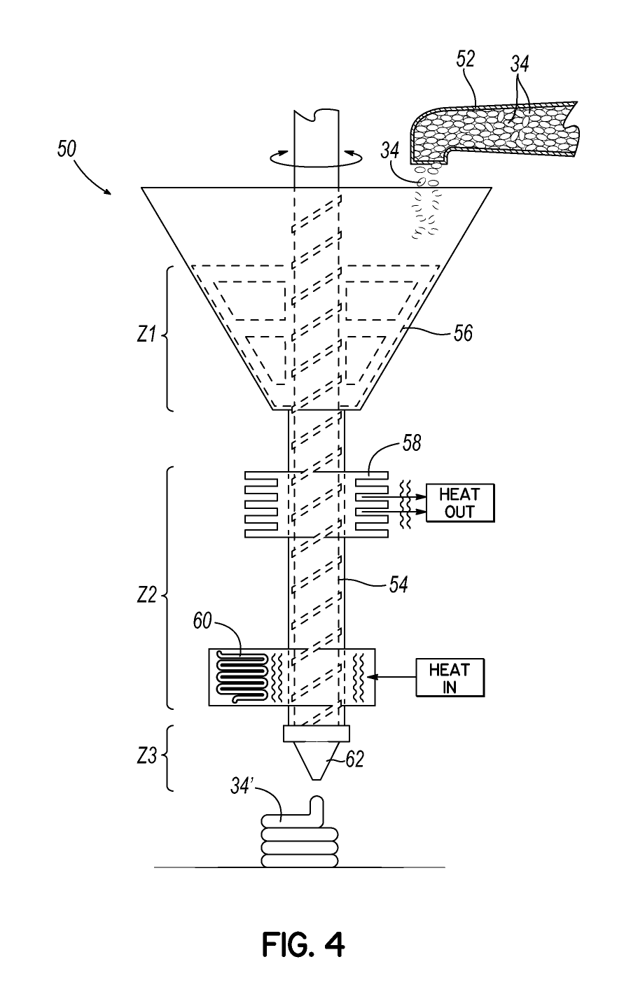

Referring now to FIG. 4, another exemplary additive manufacturing system 50 includes one or more feedstock source(s) 52, a helical drive 54, a mixing or agitating device 56 at least partially defining the mixing zone Z1, a heat sink 58 and a heat source 60 together at least partially defining the heat zone Z2, and an outlet nozzle 62 at least partially defining the extrusion zone Z3. Feedstock 34 is fed from the one or more feedstock sources 52 into the mixing or agitating zone Z1. Once in the mixing or agitating zone Z1 the feedstock material 34 is either controllably or randomly mixed. The mixing or agitation may be actively controlled and actuated via vibration, rotation, magnetism, paddles, brushes, stirring, a single sigma mixer, a dual sigma mixer, fluid flow, liquid flow, or gas flow. The mixing or agitation may be passively controlled and actuated via vibration, rotation, magnetism, paddles, brushes, stirring, a single sigma mixer, a dual sigma mixer, fluid flow, liquid flow, or gas flow. Once the feedstock 34 passes through the agitation zone Z1, the feedstock 34 is controlled through the helical drive 54. An actuator (not shown) controls the rotation of the helical drive 54. The force from the helical drive 54 applied to the feedstock 34 causes the feedstock 34 to traverse the helical drive 54, passing the heat sink 58 and further passing into the heat zone Z2. Once the feedstock 34 enters the heat zone Z2, the feedstock 34 is wholly or partially liquefied from the heat. The wholly or partially liquefied feedstock 34′ continues past the heat zone Z2 into the outlet nozzle 62. Once the wholly or partially liquefied feedstock material 34′ passes through the outlet nozzle 62, the material 34′ is deposited by the 3D printer or additive manufacturing system 50 based upon the desired toolpath. In one embodiment, a flow controller (not shown) may use the feedback received from one or more pressure or flow sensors (not shown) in order to calculate a desired outlet nozzle pressure and control the rotational speed of the lead edge of the auger or helical drive 54 relative to the inner surface of the outlet nozzle 62. In addition or alternatively, a gear pump may be positioned between the helical drive 54 and the outlet nozzle 62, in conjunction with or separately from a feedback control system or flow controller, in order to regulate the flow of liquified or semi-liquified feedstock 34′.

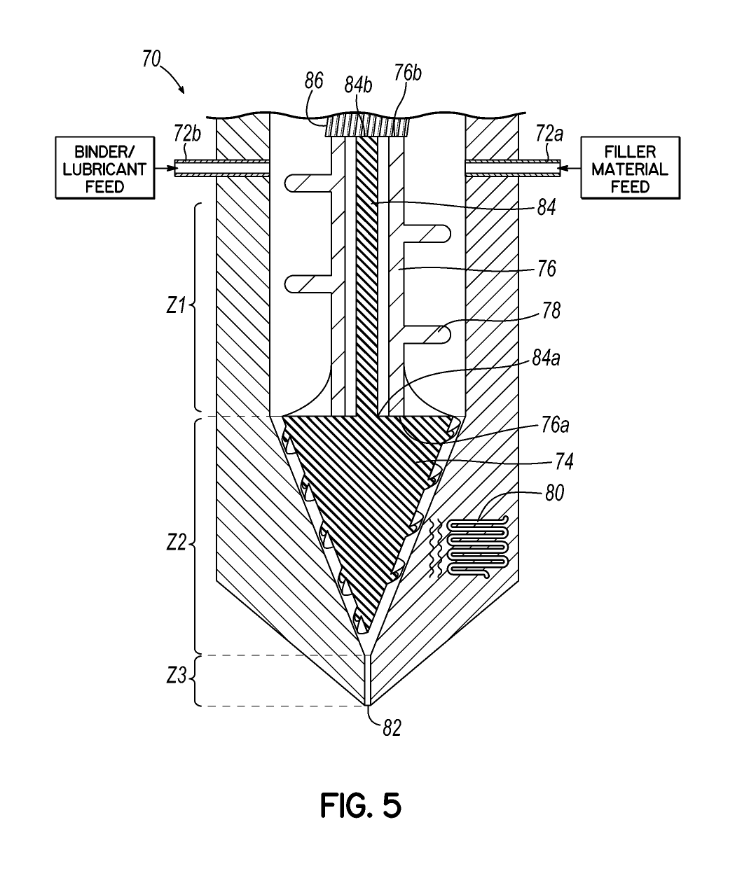

Referring now to FIG. 5, another exemplary additive manufacturing system 70 includes one or more material source(s) 72a, 72b, an auger or helical drive 74, a mixing or agitating shaft 76 having mixing paddles 78 and at least partially defining the mixing zone Z1, a heat source 80 at least partially defining the heat zone Z2, and an outlet nozzle 82 at least partially defining the extrusion zone Z3. Feedstock (not shown) is fed from one or more feedstock sources 72a, 72b into a mixing or agitating zone Z1. Once in the mixing or agitating zone Z1 the feedstock material is either controllably or randomly mixed. The mixing or agitation can be actively controlled and actuated via rotation of the mixing shaft 76. The exterior surface of the mixing shaft 76 has one or more protrusions 78. These protrusions 78 may be made of metal, polymer, composite, bristles, spikes, mesh, pegs, and/or rods. The mixing shaft 76 is hollow and contains the auger drive shaft or helical drive shaft 84. In one embodiment, the mixing shaft 76 and auger drive shaft or helical drive shaft 84 may be controlled using a common actuator and control system. In another embodiment, the mixing shaft 76 and auger drive shaft or helical drive shaft 84 may be controlled using separate and distinct actuators and control systems. In any event, the mixing shaft 76 and helical drive shaft or auger drive shaft 84 have first ends 76a, 84a, respectively, near the heat zone Z2 and second ends 76b, 84b, respectively, near the material sources 72a, 72b. The second ends 76b, 84b may each be rotated mechanically, such as via a toothed ring 86, gearbox, direct drive, pneumatics, belt, pulley, and/or chain, or electromechanically. Once the feedstock passes through the agitation zone Z1, the feedstock is controlled through the helical drive 74. An actuator (not shown) controls the rotation of the helical drive 74. The force from the helical drive 74 applied to the feedstock causes the feedstock to traverse the helical drive 74 into the heat zone Z2. Once the feedstock enters the heat zone Z2, the feedstock is wholly or partially liquefied from the heat. The wholly or partially liquefied feedstock continues past the heat zone Z2 into the outlet nozzle 82. Once the wholly or partially liquefied feedstock material passes through the outlet nozzle 82, the material is deposited by the 3D printer or additive manufacturing system 70 based upon the desired toolpath.

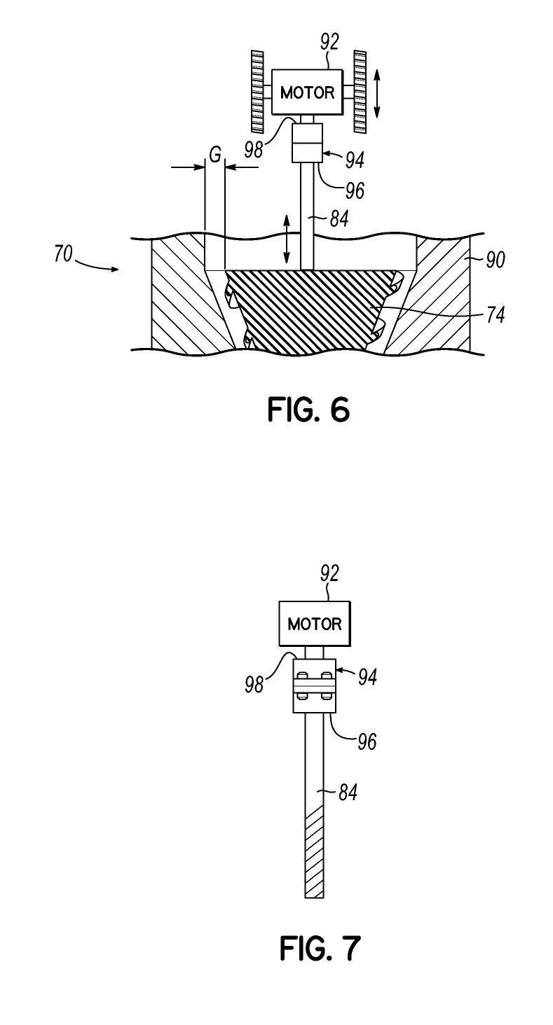

With reference now to FIG. 6, in one embodiment, the system 70 may allow for controlled movement of the auger or helical drive 74 with respect to the hollow body 90 of the system 70 to control the distance and angle between the lead edge of the auger or helical drive 74 and the inner surface of the outlet nozzle 82. The system 70 may also include a pressure sensor (not shown) configured to measure the pressure of the wholly or partially liquefied feedstock in the hollow body 90, such as within the extrusion zone Z3. In addition or alternatively, the system 70 may include a flow controller (not shown) which uses the feedback received from one or more pressure or flow sensors in order to calculate a desired outlet nozzle pressure and control the distance between the lead edge of the auger or helical drive 74 and the inner surface of the outlet nozzle 82. The distance between the inner surface of the outlet nozzle 82 and the auger or helical drive 74 may be changed by using rails, slides, rods, rack and pinion, pulleys, pneumatics, and/or hydraulics. In one embodiment of the invention the outlet nozzle 82 may be fixed and the auger or helical drive 74 may be controlled to move in order to change the separation distance. In another embodiment of the invention the auger or helical drive 74 may be fixed and the outlet nozzle 82 may be controlled to move in order to change the separation distance. In the embodiment shown, the gap size G between the helical drive 74 and the hollow body 90 decreases as the auger or helical drive 74 moves toward the outlet nozzle 82. The gap size G is inversely related to mixture pressure, such that changing the gap size G provides control over extrusion pressure as a print parameter.

As shown in FIG. 7, the auger or helical drive shaft 84 of the auger or helical drive 74 described above may be coupled to an actuator 92 via a coupler 94. The coupler 94 has first and second ends 96, 98 with the first end 96 connected to the auger or helical drive shaft 84 and the second end 98 connected to the actuator 92, where the actuator 92 may interface via the rotor of a DC motor, the rotor of an AC motor, the rotor of a stepper motor, the drive shaft of a gear box connected to a DC motor, the drive shaft of a gear box connected to an AC motor, or the drive shaft of a gear box connected to a stepper motor. In one embodiment, the coupler 94 may be constructed of a thermally resistive material or materials. For example, the coupler 94 may be polymeric, ceramic, metallic, or a carbon allotrope.

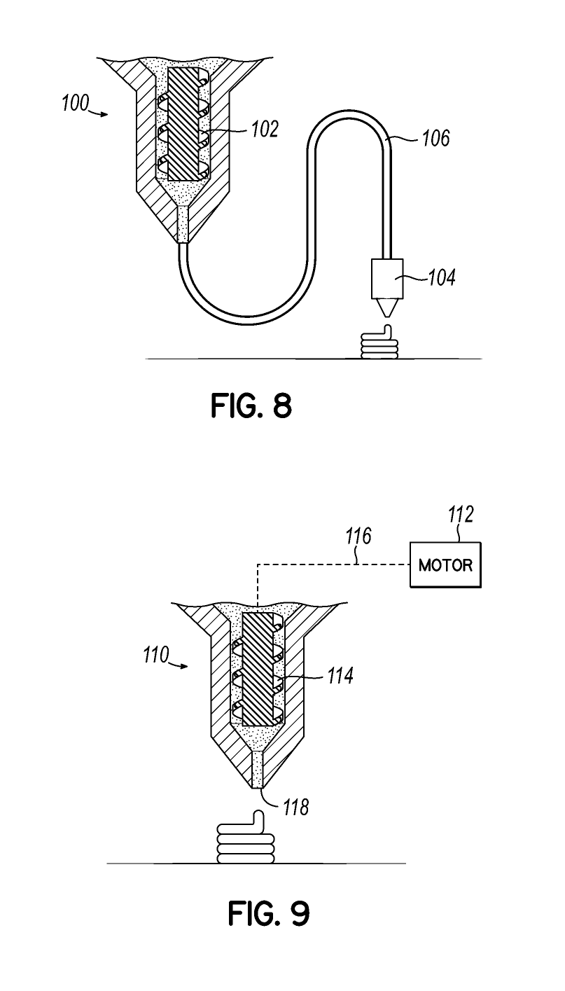

With reference now to FIG. 8, another exemplary additive manufacturing system 100 includes a helical drive or auger drive 102 separated physically and thermally from an outlet nozzle 104 by a flexible tube 106. The flexible tube 106 may be insulated. The flexible tube 106 may be actively heated. The flexible tube 106 may be constrained to move in the plane of the 3D printer gantry. The flexible tube 106 may be allowed to move freely. The flexible tube 106 may be permanently connected to one or both of the helical drive 102 and the outlet nozzle 104. The flexible tube 106 may be connected via latch, pipestrap, ziptie, glue, screw, thread, or clip to one or both of the helical drive 102 and the outlet nozzle 104. While not shown, other components of the system 100 may be generally similar to those components in the various mixing, heat, and/or extrusion zones Z1, Z2, Z3 described above.

Referring now to FIG. 9, another exemplary additive manufacturing system 110 includes an actuator 112 located remotely from but mechanically coupled to the helical drive 114, such as via a flexible shaft 116. In one embodiment, the actuator or motor 112 may be mounted in a fixed position while the helical drive 114 and outlet nozzle 118 are controlled to move by the 3D printer gantry or additive manufacturing system 110. While not shown, other components of the system 110 may be generally similar to those components in the various mixing, heat, and/or extrusion zones Z1, Z2, Z3 described above.

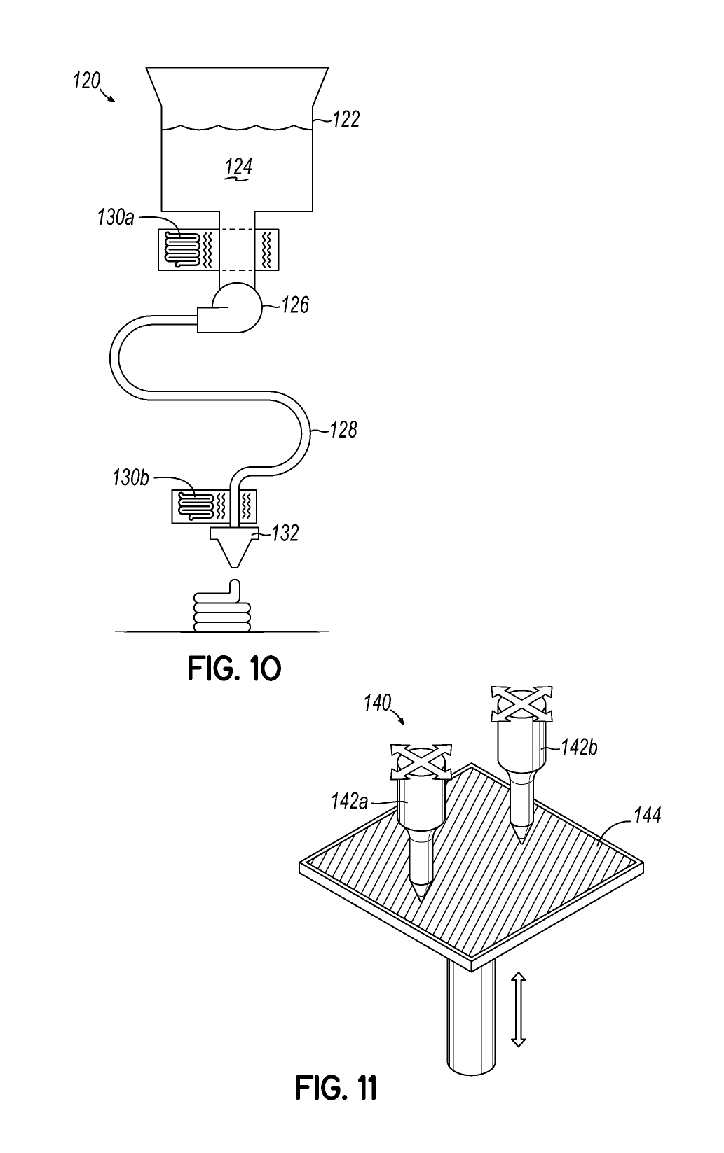

Referring now to FIG. 10, another exemplary additive manufacturing system 120 includes at least one tank 122 to hold one or more types of feedstock 124, a pump 126, a flexible low-friction tube 128, one or more heat sources 130a, 130b, and an outlet nozzle 132. The feedstock 124 can be of any suitable type, such as a liquid resin or gel or gel composite. The pump 126 may include one or more of a rotary pump, a screw drive pump, a pneumatic pump, or other suitable types of pumps.

Referring now to FIG. 11, another exemplary additive manufacturing system 140 may include multiple helical drive extruders 142a, 142b which may be mechanically movable relative to a build surface 144 in one, two, three, or more axes. The helical drive extruders 142a, 142b may be synchronized with each other or may each have at least some degree of independent control. While not shown, other components of the system 140 may be generally similar to those components in the various mixing, heat, and/or extrusion zones Z1, Z2, Z3 described above.

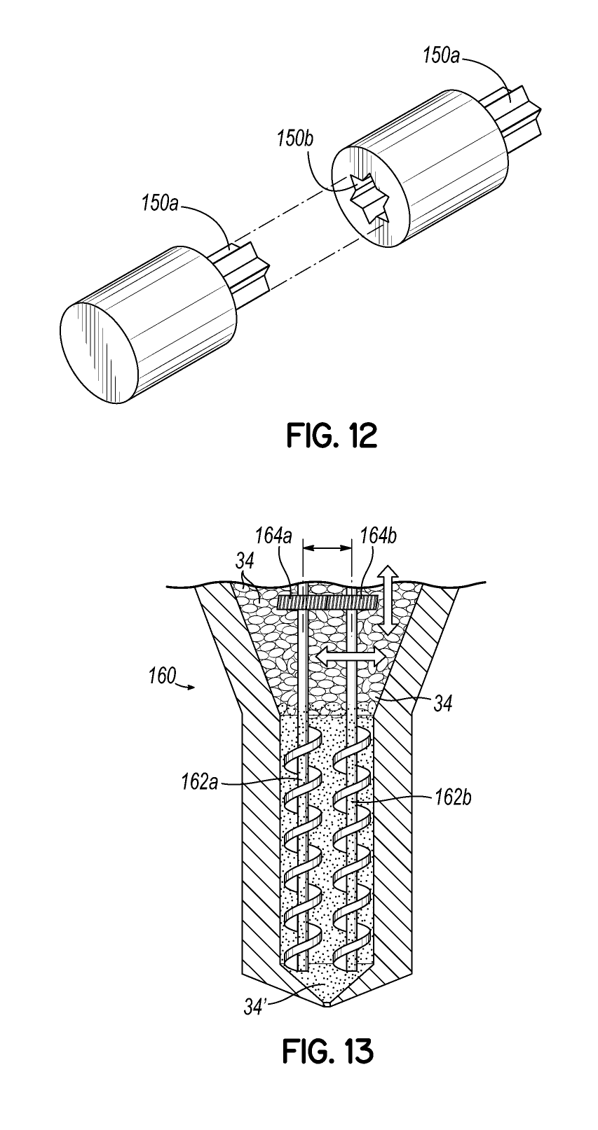

Referring now to FIG. 12, any extrusion screw, helical drive or drive shaft referenced herein may be made in a modular or interlocking way. For example, a male spline profile 150a and female spline profile 150b suitable to transmit the required torque may be used. Splines 150a, 150b may be tapered and/or spring loaded to facilitate and secure while allowing simple disassembly. Screws with many multifunctional zones in either single or multi-screw configurations may be used. These multifunctional zones may include but are not limited to feed zone, mixing zone, feedstock transition, and flow rate metering.

Referring now to FIG. 13, any helical drive extruder referenced herein may include more than one helical drive, auger, or screw. For example, the illustrated helical drive extruder 160 includes two screws 162a, 162b which may be operated together or independently via corresponding gears 164a, 164b which may be movable in and out of engagement with each other and which may either co-rotate or counter-rotate relative to each other. In one embodiment, moving the multiple screws 162a, 162b relative to each other may provide gap size control and/or pressure control, in a manner generally similar to that described above with respect to FIG. 6. Moving the screws 162a, 162b relative to each other may be particularly useful when applied in tapered extruder geometries, and may include relative axial movement (e.g., vertical movement in the drawing) as well as relative radial movement (e.g., horizontal movement in the drawing). For example, relative axial and radial movement of the screws 162a, 162b may be used to change the intermesh geometry. Subsequently, axial movement of the screws 162a, 162b in unison may be used to provide gap size control and/or pressure control, in a manner generally similar to that described above with respect to FIG. 6.

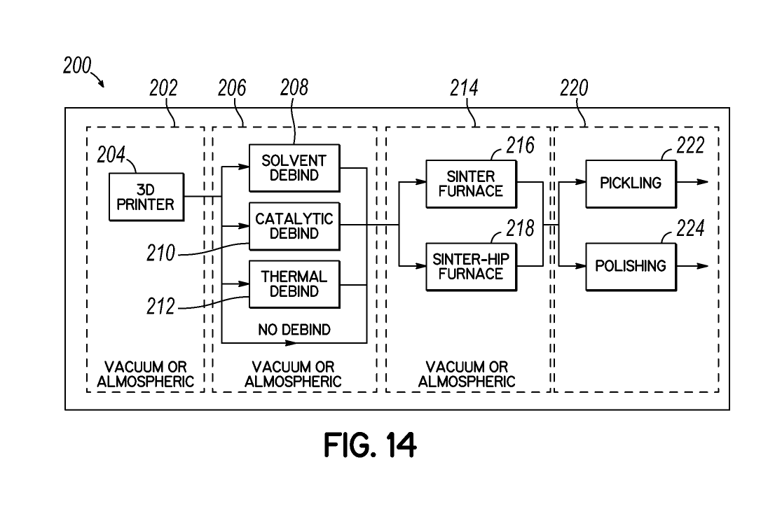

With reference now to FIG. 14, an end to end automated 3D printing workflow 200 is illustrated. For the purposes of this embodiment of the invention atmospheric shall be defined to include forming gas, forming environment, inert gas (such as, but not limited to, argon), inert environment, reducing gas, reducing environment, standard atmospheric gas (such as, but not limited to, a mix of nitrogen, oxygen, and other gases), and standard atmospheric environment. At the highest level this embodiment of the invention contains a 3D printing station 202 including a 3D printer 204 which manufactures a desired part either in a vacuum, inert, or atmospheric environment. After the part is produced, the part is subsequently manually or automatically removed from the 3D printer 204 and may enter into a washing station 206. The washing station 206, also commonly referred to as a debind station 206, may be one or a combination of a solvent debind station 208, catalytic debind station 210, thermal debind station 212, or another type of debinding station. The washing station 206 may have an actively or passively controlled vacuum environment, inert environment, or atmospheric environment. If the washing station 206 is included and once the washing is complete, the part is manually or automatically introduced to a heat treating station 214. If the washing station 206 is not included, the 3D printed part is either manually or automatically introduced to the heat treating station 214 directly from the 3D printing station 202. The heat treating station 214 may operate in a vacuum, inert, or atmospheric environment. The heat treating station 214 may be one or a combination of a sintering furnace 216, sintering—hot isostatic pressing furnace 218, or hot isostatic pressing furnace (not shown). Once the 3D printed part has completed the desired heat treating, the 3D printed part manually or automatically enters into a finishing station 220. The finishing station 220 may contain one or a combination of pickling 222 or polishing 224. For the purposes of this embodiment of the invention, actively or passively controlling the environment of each of these steps may contain one or a combination of thermal sensors, pressure sensors, chemical sensors, oxygen sensors, humidity sensors, and means for regulating and controlling the temperature, pressure, chemistry, oxygen, and humidity within each of the substations of the workflow 200.

While the present invention has been illustrated by the description of various embodiments thereof, and while the embodiments have been described in considerable detail, it is not intended to restrict or in any way limit the scope of the appended claims to such detail. Thus, the various features discussed herein may be used alone or in any combination. Additional advantages and modifications will readily appear to those skilled in the art. The present invention in its broader aspects is therefore not limited to the specific details and illustrative examples shown and described. Accordingly, departures may be made from such details without departing from the scope of the general inventive concept.

What is claimed is:

1. An additive manufacturing system, comprising:
a hopper for containing a feedstock;
at least one helical drive positioned downstream from the hopper for receiving the feedstock therefrom;
a heat source positioned proximate at least a portion of the at least one helical drive; and
an outlet,
wherein the at least one helical drive is configured to advance the feedstock toward the outlet, wherein the heat source is configured to at least partially liquefy the feedstock advanced by the at least one helical drive, and wherein the outlet is configured to dispense the at least partially liquefied feedstock based on a desired toolpath.

2. The additive manufacturing system of claim 1, wherein the at least one helical drive includes at least one of a screw, a bolt, an auger, or an Archimedean screw.

3. The additive manufacturing system of claim 1, further comprising:
a mixing subsystem positioned upstream from the at least one helical drive for mixing at least one of the feedstock, a lubricant, or a binder.

4. The additive manufacturing system of claim 3, wherein the mixing subsystem includes at least one of a vibrator, a rotating shaft, a magnet, a paddle, a brush, a stirrer, a single sigma mixer, a dual sigma mixer, a fluid flow, a liquid flow, or a gas flow.

5. The additive manufacturing system of claim 3, wherein the at least one helical drive and the mixing subsystem are driven in unison with each other.

6. The additive manufacturing system of claim 3, wherein the at least one helical drive and the mixing subsystem are driven independently of each other.

7. The additive manufacturing system of claim 1, wherein the hopper includes at least one protrusion for controlling flow of the feedstock from the hopper.

8. The additive manufacturing system of claim 7, wherein the at least one protrusion is at least one of stationary, rotatable, linearly movable, extendable in length and/or retractable in length.

9. The additive manufacturing system of claim 1, wherein the at least one helical drive is linearly movable relative to the outlet.

10. The additive manufacturing system of claim 9, wherein linear movement of the at least one helical drive relative to the outlet is controllable.

11. The additive manufacturing system of claim 1, further comprising:
an actuator for driving the at least one helical drive, wherein the actuator is operatively coupled to the at least one helical drive by a coupler constructed of at least one thermally resistive material.

12. The additive manufacturing system of claim 11, wherein the coupler is constructed of at least one of a polymer, a ceramic, a metal, or a carbon allotrope.

13. The additive manufacturing system of claim 1, further comprising:
a flexible tube positioned between the at least one helical drive and the outlet.

14. The additive manufacturing system of claim 13, wherein the flexible tube is actively heated.

15. The additive manufacturing system of claim 1, further comprising:
a feedstock comprising a non-filament material, wherein the feedstock is contained in the hopper.

16. The additive manufacturing system of claim 15, wherein the feedstock is selected from the group consisting of polymer pellets, polymer granules, polymer powders, polymer gels, polymer suspensions, polymer micro pellets, metal pellets, metal granules, metal powders, metal gels, metal suspensions, metal micro pellets, graphite pellets, graphite granules, graphite powders, graphite gels, graphite suspensions, graphite micro pellets, ceramic pellets, ceramic granules, ceramic powders, ceramic gels, ceramic suspensions, ceramic micro pellets, and/or combinations or composites thereof.

17. An additive manufacturing system, comprising:
a tank for containing a feedstock;
a pump positioned downstream from the tank for receiving the feedstock therefrom;
a heat source positioned proximate the pump; and
an outlet,
wherein the pump is configured to advance the feedstock toward the outlet, wherein the heat source is configured to at least partially liquefy the feedstock advanced by the pump, and wherein the outlet is configured to dispense the at least partially liquefied feedstock based on a desired toolpath.

18. The additive manufacturing system of claim 17, further comprising:
a flexible tube positioned between the helical drive and the outlet.

19. The additive manufacturing system of claim 18, wherein the flexible tube is actively heated.

20. A method of manufacturing, comprising:
feeding a feedstock into a hopper;
advancing the feedstock from the hopper through a heat zone via a helical drive;
at least partially liquefying the feedstock in the heat zone; and
dispensing the at least partially liquefied feedstock based on a desired toolpath.
